(19) United States
(12) Patent Application Publication
(10) Pub. No.: US 2025/0363790 A1
(43) Pub. Date: Nov. 27, 2025

(54) IMAGE PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Zhen LI, Shenzhen (CN); Xintao WANG, Shenzhen (CN); Mingdeng CAO, Shenzhen (CN); Zhongang QI, Shenzhen (CN); Ying SHAN, Shenzhen (CN); Mingming CHENG, Shenzhen (CN)

(21) Appl. No.: 19/285,940

(22) Filed: Jul. 30, 2025

Related U.S. Application Data
(63) Continuation of application No. PCT/CN2024/099534, filed on Jun. 17, 2024.

(30) Foreign Application Priority Data
Jun. 30, 2023 (CN) 202310798558.8

(51) Int. Cl. G06V 10/80; G06V 10/70

(52) U.S. Cl. CPC G06V 10/806; G06V 10/768

(57) ABSTRACT

An image processing method includes: obtaining an input image comprising a preset object, and obtaining text data; encoding the text data to obtain a text embedding feature; performing image feature extraction on the input image according to a plurality of predefined data dimensions, to obtain identity embedding features of the preset object in the data dimensions; and fusing and recognizing the identity embedding features of the preset object in the data dimensions and the text embedding feature by using an interlaced condition mechanism, to generate an output image that includes the preset object and that includes a feature described by the text data.

### CROSS-REFERENCES TO RELATED APPLICATIONS

This application is a continuation of PCT Application No. PCT/CN2024/099534, filed on Jun. 17, 2024, which claims priority to Chinese Patent Application No. 2023107985588, entitled “IMAGE PROCESSING METHOD AND APPARATUS, COMPUTER DEVICE, STORAGE MEDIUM, AND PRODUCT” filed with the China National Intellectual Property Administration on Jun. 30, 2023, the entire contents of all of which are incorporated herein by reference.

### FIELD OF THE TECHNOLOGY

The present disclosure relates to the field of computer technologies, and in particular, to an image processing method, an image processing apparatus, a computer device, and a computer-readable storage medium.

### BACKGROUND OF THE DISCLOSURE

With the widespread applications of artificial intelligence, an image processing technology has permeated all aspects of daily life. Practices show that there are increasing demands for text-driven image generation to produce personalized images for users.

At present, a personalized image generation mode is usually to extract a text feature from text data and directly generate a personalized image based on the text feature. The personalized image generated by this mode is relatively simple and is not accurate enough.

### SUMMARY

Embodiments of the present disclosure provide an image processing method and apparatus, a computer device, a storage medium, and a product, which can improve accuracy of a personalized image.

According to an aspect, an embodiment of the present disclosure provides an image processing method, including: obtaining an input image including a preset object, and obtaining text data; encoding the text data to obtain a text embedding feature; performing image feature extraction on the input image according to a plurality of predefined data dimensions, to obtain identity embedding features of the preset object in the data dimensions; and invoking a text-to-image generation model to fuse and recognize the text embedding feature of the preset object and the identity embedding features of the preset object in the data dimensions, to generate an output image, the text-to-image generation model including a plurality of cross attention layers, and the text embedding feature and the identity embedding features in the data dimensions being alternately inputted to the cross attention layers; and the output image including an image feature that is described by the text data and that is related to the preset object in the input image.

According to an aspect, an embodiment of the present disclosure provides an image processing apparatus, including: an obtaining unit, configured to: obtain an input image including a preset object, and obtain text data; and a processing unit, configured to encode the text data to obtain a text embedding feature; the processing unit being further configured to perform image feature extraction on the input image according to a plurality of predefined data dimensions, to obtain identity embedding features of the preset object in the data dimensions; and the processing unit being further configured to: invoke a text-to-image generation model to fuse and recognize the text embedding feature of the preset object and the identity embedding features of the preset object in the data dimensions, to generate an output image, the text-to-image generation model including a plurality of cross attention layers, and the text embedding feature and the identity embedding features in the data dimensions being alternately inputted to the cross attention layers; and the output image including an image feature that is described by the text data and that is related to the preset object in the input image.

According to an aspect, an embodiment of the present disclosure provides a computer device, including a memory and a processor. The memory has a computer program stored therein, and the computer program, when executed by a processor, causes the processor to perform the above image processing method.

According to an aspect, an embodiment of the present disclosure provides a non-transitory computer-readable storage medium, having a computer program stored therein. The computer program, when read and executed by a processor of a computer device, causes the computer device to perform the above image processing method.

In the embodiments of the present disclosure, first, an input image that includes a preset object, and text data can be obtained. The text data is configured for describing a personalized feature of the preset object. Then, the text data is encoded to obtain a text embedding feature. Image feature extraction is performed on the preset object in the input image according to a plurality of data dimensions, to obtain identity embedding features of the preset object in the data dimensions. Finally, the identity embedding features of the preset object in the data dimensions and the text embedding feature of the project object are fused and recognized, to generate a personalized image that is matched with the preset object. Therefore, during the extraction of an image feature of the preset object, the present disclosure can perform multi-dimensional feature extraction, so that the identity embedding features of the preset object can be more comprehensively and accurately extracted. In addition, in the process of generating the personalized image based on the identity embedding features and the text feature, feature data is processed through a plurality of cross attention layers designed in a text-to-image generation model, to balance a conflict between the identity embedding features and the text embedding feature, so that contributions made by different features can be properly balanced in the image generation process, and the generated output image can better meet a personalized demand described in the text data.

### BRIEF DESCRIPTION OF THE DRAWINGS

FIG. 1 is a schematic diagram of an image processing scheme according to an embodiment of the present disclosure.

FIG. 2 is a schematic structural diagram of an image processing system according to an embodiment of the present disclosure.

FIG. 3 is a flowchart of an image processing method according to an embodiment of the present disclosure.

FIG. 4 is a schematic diagram of an interface for obtaining text data according to an embodiment of the present disclosure.

FIG. 5 is a schematic diagram of an interface for extracting a local identity embedding according to an embodiment of the present disclosure.

FIG. 6 is a flowchart of interlaced conditioning according to an embodiment of the present disclosure.

FIG. 7 is a flowchart of another image processing method according to an embodiment of the present disclosure.

FIG. 8 is a schematic diagram of an image processing scenario according to an embodiment of the present disclosure.

FIG. 9 is a schematic structural diagram of an image processing apparatus according to an embodiment of the present disclosure.

FIG. 10 is a schematic structural diagram of a computer device according to an embodiment of the present disclosure.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The following implementations described in the following exemplary embodiments do not represent all implementations that are consistent with the present disclosure. On the contrary, the implementations are merely examples of an apparatus and a method consistent with some aspects of the present disclosure as detailed in the appended claims.

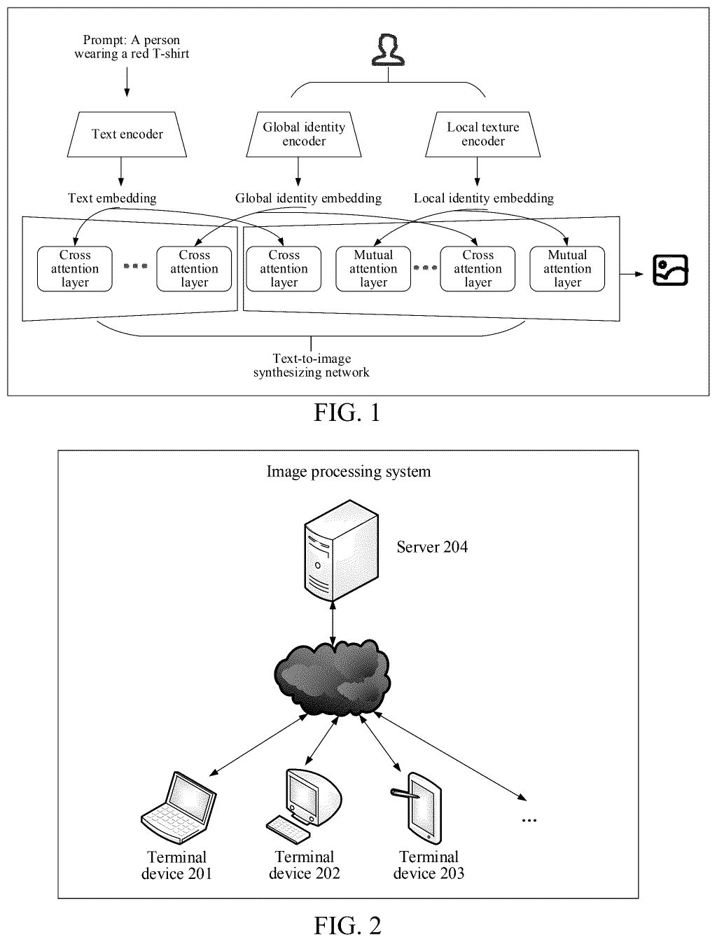

The present disclosure provides an image processing solution which can extract multi-dimensional identity features and generate a personalized image by fusion according to the multi-dimensional identity features and a text feature. This can improve accuracy and efficiency of image processing. In the present disclosure, an interlaced condition mechanism may be used to perform interlaced conditioning on a global identity embedding and a text embedding, to avoid a problem of imbalanced feature contributions caused by a factor that the identity features play a dominant role. In addition, in the present disclosure, a local enhancement mechanism may be further used to enhance a local identity embedding, to reserve more local texture information of a user, thereby improving accuracy of generating a personalized image. FIG. 1 is a schematic diagram of an image processing scheme according to an embodiment of the present disclosure. A framework shown in FIG. 1 mainly includes three encoders and a text-to-image synthesizing network (hereinafter referred to as a text-to-image generation model). A first encoder is a text encoder, which is responsible for converting input text data into a text embedding yₚ (also referred to as text embedding feature). A second encoder is a global identity encoder, which is responsible for abstracting particular identity information of a preset object (the preset object may be a preset object that needs to be personalized, for example, some persons or animals) in an input image into a global identity embedding y_{global} (also referred to as global identity embedding feature). A third encoder is a local texture encoder, which extracts a hierarchical spatial embedding (also hereinafter referred to as a local identity embedding or local identity embedding feature) from the input image that includes the preset object, to reserve more texture details. After these embeddings (the text embedding, the global identity embedding, and the local identity embedding) are obtained, the synthesizing network is responsible for effectively fusing them together, to generate a personalized image that has identity information consistency and that conforms to a text description. In a process of generating a personalized image, the text embedding and the global identity embedding may be placed on a cross attention layer through an interlaced condition mechanism, to avoid a conflict between text and identity control. In addition, the local identity embedding may be transmitted into a local identity enhancement branch of a modified UNet decoder. The branch adaptively integrates multi-layer spatial embeddings by using parallel mutual attention layers. Based on the interlaced condition mechanism and a local enhancement mechanism, a personalized feature described by text data can be more accurately represented in an output image, thereby improving accuracy and generation efficiency of the personalized image.

The following roughly describes the principle of the image processing scheme provided in the present disclosure with reference to FIG. 1.
(1) In a process of generating a personalized image, an input image that includes a user (a preset object) may be first obtained. For example, the input image may include parts such as the face, the head, and the limbs of the user. Moreover, a segment of text data for describing a personalized feature of the user is obtained. For example, the text data (Prompt) is: A person wearing a red T-shirt. The input image and the text data may be configured for generating the personalized image.
(2) The framework for generating a personalized image shown in FIG. 1 includes: three encoders (a text encoder, a global identity encoder, and a local texture encoder) and a text-to-image generation model. The global identity encoder and the local texture encoder are configured to perform image feature extraction on a preset object in an input image in different data dimensions, to obtain identity embeddings of the preset object in the data dimensions. For example, the data dimensions may include: a global dimension and a local dimension. Specifically, the text encoder is used to encode text data, to obtain a text embedding. The global identity encoder is used to perform image feature extraction on the input image, to obtain a global identity embedding. The local texture encoder is used to perform image feature extraction on the input image, to obtain a local identity embedding.
(3) The text embedding, the global identity embedding, and the local identity embedding are inputted to the text-to-image generation model, to generate a personalized image that is matched with the preset object. Specifically, an interlaced condition mechanism is used to perform interlaced conditioning on the text embedding and the global identity embedding. To be specific, the text embedding and the global identity embedding are inputted to cross attention layers in an interlaced manner. For example, the text feature is inputted to a first cross attention layer, and then the global identity embedding is inputted to a second cross attention layer; and the text feature is inputted to a third cross attention layer, and then the global identity embedding is inputted to a fourth cross attention layer. The rest can be deduced by analogy. In addition, a local enhancement mechanism may further be used to perform feature enhancement on the local identity embedding. To be specific, the local identity embedding is inputted to a mutual attention layer for local feature enhancement. Finally, after recognition based on the text-to-image generation model, the personalized image that is matched with the preset object may be generated.

Next, key technical terms related to the image processing scheme are described in detail.

### I. Text Data, and Personalized Feature:

The text data is data that uses text to describe a personalized feature of a preset object in a to-be-generated personalized image. In other words, the text data is usually a text description. The data format of the text data may be Chinese, English, a character string, a code, or the like. The present disclosure does not impose a specific limitation on this. For example, the text data may be represented in English as: A person wearing a red T-shirt. For example, the text data may be further represented in Chinese as: [symbol] [symbol] [symbol] [symbol] [symbol] [symbol] T [symbol] [symbol] [symbol] .

The personalized feature is at least one feature for describing clothes, makeup, or behaviors of the preset object, or an environment in which the preset object is. For example, the personalized feature may be configured for describing a clothes feature of the preset object, such as a clothes color, a clothes style, or clothes matching. For another example, the personalized feature may be configured for describing a makeup and hairstyle feature such as a makeup look, a hair color, or a hair length of the preset object. For still another example, the personalized feature may be configured for describing an action feature of the preset object, such as playing a ball, moving, or running.

### II. Identity Embedding:

The identity embedding is configured for describing object image features of a preset object in different data dimensions. For example, if a data dimension is a global dimension, an identity embedding of the preset object in the global dimension may be represented as a global identity embedding, and the global identity embedding may be configured for reflecting global identity information of the preset object, such as a position in an image, gender (male or female), age (child, teenager, elderly, or adult), and another feature. For another example, if the data dimension is a local dimension, an identity embedding of the preset object in the local dimension may be represented as a local identity embedding, and the local identity embedding may be configured for reflecting local texture information of the preset object. For example, if a to-be-processed object includes a face of the preset object, the local identity embedding may include: an eye feature (single eyelids and double eyelids), a mouth feature (thick lips and cherry-like lips), a skin type (dry skin, oil skin, mixed dry skin, and mixed oil skin), and another facial feature. For another example, the to-be-processed object includes the head of the preset object, and the local identity embedding may include: high cranial vertex, a hair color (black, brown, and red), a hair style (curly hairs or straight hairs), long hairs or short hair, and another feature.

### III. Interlaced Condition Mechanism:

The interlaced condition mechanism is a mechanism for performing interlaced conditioning on two or more features. In the present disclosure, the interlaced condition mechanism is configured for performing interlaced conditioning on a global identity embedding of a preset object in a global dimension, and a text embedding. The interlaced conditioning means that the global identity embedding and the text embedding are alternately inputted to cross attention layers of a text-to-image generation model, and interlaced conditioning is performed on the global identity embedding and the text embedding based on the cross attention layers. In other words, the interlaced condition mechanism may balance a difference between the global identity embedding and the text embedding in a process of generating a personalized image. Specifically, this mechanism is applied to the cross attention layers of the text-to-image generation model, mainly to solve a problem that the global identity embedding of the preset object is a leading factor and the text embedding loses control over the personalized image. This mechanism allows different conditions (i.e., text data) to be independently added, without conflicts.

### IV. Personalized Image:

The personalized image is an image that is generated based on text data and that is matched with a preset object. The matching means: An identity feature of the personalized image is consistent with an identity feature of the preset object. The identity feature herein may include: any one or more of a facial feature, a fingerprint feature, a palm feature, and a pupil feature. To be specific, the personalized image is an image generated for the preset object according to a personalized feature described by text data. For example, an input image includes person A, and the text data is represented as: A person wearing a red T-shirt. The generated personalized image is an image including person A wearing a red T-shirt. For another example, an input image includes person B, and the text data is represented as: A man wearing a hat. The generated personalized image is an image including person B wearing a hat.

### V. Artificial Intelligence:

Artificial intelligence (AI) is a theory, method, technology, and application system that uses a digital computer or a machine controlled by the digital computer to simulate, extend, and expand human intelligence, perceive an environment, acquire knowledge, and use knowledge to obtain an optimal result. The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

A computer vision (CV) technology is a science that studies how to use a machine to “see”, and the computer vision further refers to using a camera and a computer instead of human eyes to implement machine vision, such as recognition, detection, and measurement of a target, and further performing graphic processing, so that the computer processes the target into an image more suitable for human eyes to observe, or an image transmitted to an instrument for detection. As a scientific discipline, CV studies are related to theories and technologies and attempt to establish an AI system that can obtain information from images or multidimensional data. A large model technology brings an important change to development of the CV technology. Pre-trained models in the vision field, such as a swin-transformer, a ViT transformer, a V-MOE (which is a vision architecture), and a mask auto encoder (MAE) can be quickly and widely applicable to specific downstream tasks via fine tune. The CV technology generally includes technologies such as image processing, image recognition, image semantic understanding, image retrieval, optical character recognition (OCR), video processing, video semantic understanding, video content/behavior recognition, three-dimensional object reconstruction, 3D technology, virtual reality, augmented reality, and simultaneous localization and mapping, and further includes common biometric recognition technologies such as face recognition and fingerprint recognition.

The image processing scheme provided in the present disclosure mainly involves a CV technology in the AI field. Specifically, a pre-training model may be trained by using a CV technology. The pre-training model may be a text-to-image generation model (such as a text-to-image synthesizing network shown in FIG. 1). Subsequently, the trained text-to-image generation model may be invoked to fuse and recognize identity embeddings of a preset object in data dimensions in an input image, and a text embedding, to generate a personalized image (i.e., an output image) that is matched with the preset object. The pre-training model, also referred to as a cornerstone model and a large model, is a deep neural network (DNN) having a large parameter. A large amount of unmarked data is used to train the pre-training model. A function approximation capability of the DNN with the large parameter is used to enable the pre-training model (PTM) to extract a common feature from the data. By using a technology such as fine tune, parameter efficient fine tune (PEFT), and prompt-tuning, the PTM is applicable to downstream tasks (namely, the PTM may be invoked to fuse and recognize the identity embeddings of the preset object in the data dimensions and the text embedding of the preset object, to generate the personalized image that is matched with the preset object). Therefore, the pre-training model may achieve an ideal effect in a few-shot or Zero-shot scenario. The PTM may be classified into language models (ELMO, BERT, GPT), vision models (swin-transformer, VIT, V-MOE), voice models (VALL-E), multimodal models (ViBERT, CLIP, Flamingo, Gato), and the like according to processed data modalities. The multimodal model means a model for establishing two or more data modality feature representations. The pre-training model is an important tool for outputting artificial intelligence generated content (AIGC), and may alternatively be used as a general-purpose interface for connecting a plurality of specific task models.

### VI. Cloud Technology:

The cloud technology is a general term of a network technology, an information technology, an integration technology, a management platform technology, and an application technology based on a cloud computing business model application, and may form a resource pool to satisfy what is needed in a flexible and convenient manner. A cloud computing technology will become an important support. The background service of a technical network system requires many computing and storage resources, for example, video websites, image websites, and more portal websites. With the rapid development and application of the Internet industry, each item may have its own recognition mark in the future, and the recognition marks need to be transmitted to a backend system for logical processing. Data of different levels is processed separately, and all kinds of industry data require a strong system support, which can be achieved only through the cloud computing.

In this embodiment of the present disclosure, text data is encoded to obtain a text embedding. Image feature extraction is performed on a preset object in the input image according to a plurality of data dimensions, to obtain identity embeddings of the preset object in the data dimensions. Processes such as fusing and recognizing the identity embeddings of the preset object in the data dimensions and the text embedding of the preset object by using an interlaced condition mechanism, to generate a personalized image that is matched with the preset object all involve a large amount of data computing and data storage services. The foregoing processes require lots of computer operation costs. Therefore, in the present disclosure, related operation processes such as image processing and data screening may be implemented based on a cloud computing technology. The cloud computing is a computing mode in which computing tasks are distributed on a resource pool formed by a large number of computers, so that various application systems can obtain computing power, storage space, and information services according to requirements. A network providing a resource is referred to as a “cloud”. For a user, resources in the “cloud” seem to be infinitely expandable, and may be obtained readily, used on demand, expanded readily, and paid for use.

### VII. Blockchain Technology:

A blockchain is a new application mode of computer technologies such as distributed data storage, peer to peer (P2P) transmission, a consensus mechanism, and an encryption algorithm. A blockchain is essentially a decentralized database and is a string of data blocks (also referred to as blocks) associated with cryptographic methods. Each data block includes a batch of network transaction information and is configured for verifying the validity (anti-counterfeiting) of information thereof and generating a next block. The blockchain ensures, in a cryptographic mode, that data cannot be tampered with and cannot be forged.

In the present disclosure, an image processing process specifically relates to: a plurality of pieces of data such as an input image, text data, a text embedding, identity embeddings in data dimensions, and a personalized image. In some embodiments, in the present disclosure, the above data may be transmitted to a blockchain for storage, and service data may be prevented from being tampered with or leaked based on features such as untamperable and traceable characteristics of the blockchain, thereby improving data security and reliability in the image processing process.

In the present disclosure, related data in the image processing process is, for example: an input image, text data, a text embedding, identity embeddings in data dimensions, a personalized image, and the like. When the above embodiment of the present disclosure is applied to a specific product or technology, user permission or consent needs to be obtained. Furthermore, processes of acquiring, using, and processing relevant data need to comply with the relevant laws, regulations and standards of the country and region, conform to the principles of legality, propriety and necessity, and not involve obtaining data types prohibited or restricted by laws and regulations. In some embodiments, the related data in this embodiment of the present disclosure is obtained after being separately authorized by an object. In addition, when the separate authorization of the object is obtained, a purpose of the related data is indicated to the object.

The following will make a detailed introduction to an image processing system according to an embodiment of the present disclosure.

FIG. 2 is a schematic architecture diagram of an image processing system according to an embodiment of the present disclosure. The architecture diagram of the image processing system includes: a server 204 and a terminal device cluster. The terminal device cluster includes: a plurality of terminal devices such as a terminal device 201, a terminal device 202, and a terminal device 203. A quantity of the terminal devices in the terminal device cluster is only for an example purpose. This embodiment of the present disclosure does not impose a limitation on the quantity of the terminal devices. Any terminal device in the terminal device cluster may be directly or indirectly connected to the server 204 in a wired or wireless communication mode.

Each terminal device in the terminal device cluster may be a mobile phone, a tablet computer, a notebook computer, a palmtop computer, a mobile internet device (MID), an in-vehicle device, an aircraft, a wearable device (a smart device such as a smart watch, a smart band, or a pedometer), a virtual reality device (such as a virtual reality (VR) device or an augmented reality (AR) device), or the like. Types of the terminal devices in the terminal device cluster may be the same or different. For example: The terminal device 201 may be a mobile phone, and the terminal device 202 may be a mobile phone. For another example, the terminal device 201 may be a tablet computer, and the terminal device 203 may be an in-vehicle device. The present disclosure does not impose a limitation on the quantity and types of the terminal devices in the terminal device cluster.

The server 204 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

Next, any terminal device (for example, the terminal device 201) in the image processing system is used as an example to correspondingly describe an interaction process between the terminal device 201 and the server 204.
(1) The terminal device 201 may obtain an input image including a preset object, and obtain text data. The text data is configured for describing a personalized feature of the preset object.
(2) The terminal device 201 may transmit the input image and the text data to the server 204. A text encoder, a global identity encoder, a local texture encoder, and a text-to-image generation model are configured in the server 204. The text encoder is configured to encode the text data. The global identity encoder and the local texture encoder are respectively configured to extract identity embeddings of the preset object in different data dimensions in the input image.
(3) The server 204 may invoke the text encoder to encode the text data, to obtain a text feature, and the server 204 performs image feature extraction on the preset object in the input image according to a plurality of data dimensions, to obtain identity embeddings of the preset object in the data dimension. Specifically, the global identity encoder is invoked to perform image feature extraction on the preset object in the input image according to a global dimension, to obtain a global identity embedding of the preset object; and the local texture encoder is invoked to perform texture feature extraction on the preset object in the input image according to a local dimension, to obtain a local identity embedding of the preset object.
(4) The server 204 fuses and recognizes the text embedding and the identity embeddings of the preset object in the data dimensions, to generate an output image, the output image including an image feature that is described by the text data and that is related to the preset object in the input image. The server 204 may fuse and recognize the identity embeddings (the global identity embedding and the local identity embedding) of the preset object in the data dimensions and the text embedding by using an interlaced condition mechanism, to generate a personalized image that is matched with the preset object. The interlaced condition mechanism is configured for: balancing a difference between the identity embedding in any data dimension and the text embedding in the personalized image generation process. In an embodiment, the server 204 may invoke a text-to-image generation model to fuse and recognize the text embedding of the preset object and the identity embeddings of the preset object in the data dimensions, to generate an output image, the text-to-image generation model including a plurality of cross attention layers, and the text embedding and the identity embeddings in the data dimensions being alternately inputted to the cross attention layers.
(5) The server 204 transmits a generated output image to the terminal device 201, the output image being a personalized image about the preset object in the input image.

Here, the above interaction process of image processing is merely used as an example, and does not limit specific execution processes of the terminal device and the server. In some embodiments, text data is encoded to obtain a text embedding. Image feature extraction is performed on a preset object in an input image according to a plurality of data dimensions, to obtain identity embeddings of the preset object in the data dimensions. The above processes may alternatively be performed by a terminal device. Or, text data is encoded to obtain a text embedding. Image feature extraction is performed on a preset object in the input image according to a plurality of data dimensions, to obtain identity embeddings of the preset object in the data dimensions. A plurality of cross attention layers included in the text-to-image generation model and an interlaced condition mechanism are used to fuse and recognize the identity embeddings of the preset object in the data dimensions and the text embedding of the preset object, to generate an output image (i.e., a personalized image) that is matched with the preset object. The above process may alternatively be independently performed by any terminal device or the server in the image processing system.

In one embodiment, the image processing system according to this embodiment of the present disclosure may be deployed on a node of a blockchain. For example, the server 204 and each terminal device (such as the terminal device 201, the terminal device 202, and the terminal device 203) included in the terminal device cluster may be considered as node devices of the blockchain, to jointly form a blockchain network. Therefore, in the present disclosure, an image processing procedure for a first timeliness recognition model or an image processing procedure for a second timeliness recognition model may be performed on the blockchain. In this way, fairness of the image processing procedures can be ensured. Meanwhile, the image processing procedure can be traceable, and data security during image processing can be ensured, thereby improving security and reliability of the entire image processing procedure.

In this embodiment of the present disclosure, the identity embeddings of the preset object can be more comprehensively and accurately extracted. In the process of generating the personalized image based on the identity embeddings and the text embedding, the used text-to-image generation model including the plurality of cross attention layers uses the interlaced condition mechanism to balance a conflict between the identity embeddings and the text embedding, so that contributions made by different features are properly balanced in the image generation process, and the generated personalized image can be more accurate.

The schematic architecture diagram described in this embodiment of the present disclosure is for more clearly describing the technical solution in this embodiment of the present disclosure, and does not constitute a limitation on the technical solution according to this embodiment of the present disclosure. Persons of ordinary skill in the art may learn that, with evolution of a network architecture and appearance of a new service scenario, the technical solution according to this embodiment of the present disclosure is also applicable to a similar technical problem.

The following will describe specific embodiments involved in the image processing scheme in detail with reference to the accompanying drawings.

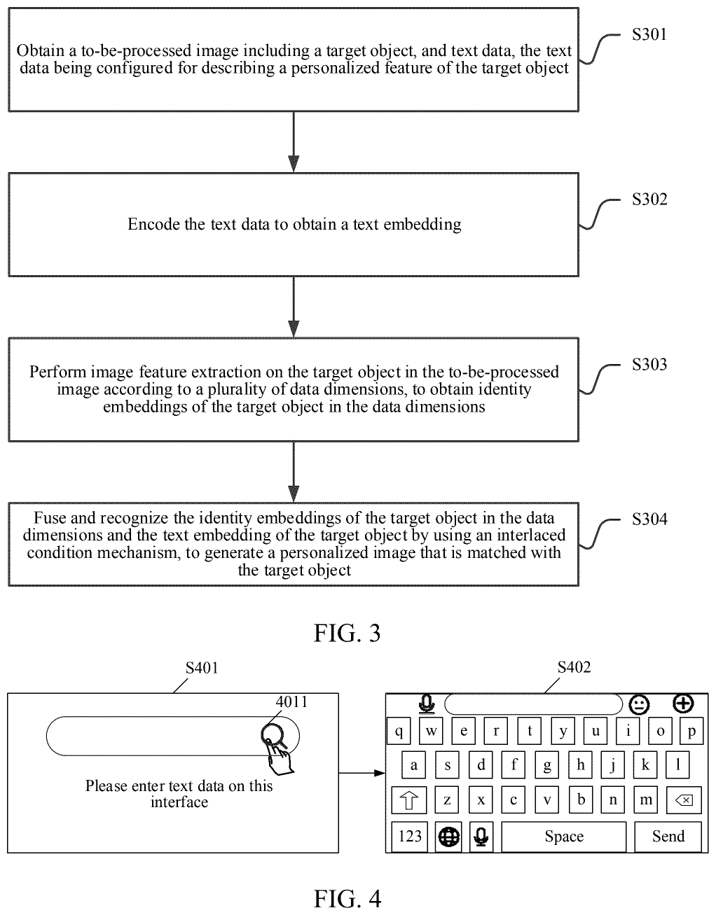

FIG. 3 is a flowchart of an image processing method according to an embodiment of the present disclosure. The image processing method may be performed by a computer device. The computer device may be a terminal device or the server in the image processing system shown in FIG. 2. The image processing method mainly includes, but is not limited to, the following operations S301-S304:

S301: Obtain an input image including a preset object, and obtain text data. The text data is configured for describing a personalized feature of the preset object. The personalized feature of the preset object that is described by the text data is: The text data is configured for describing a feature that is included in an output image corresponding to the input image and that is related to the preset object. To be specific, the feature described by the text data may be displayed in an output image finally generated through S301 to S304. For example, the text data is a person “wearing clothes in red”, and describes a personalized feature of “wearing clothes in red” related to a person object (the preset object). In this case, the person object wearing clothes in red may be finally displayed in the personalized image after a series of processing of S302 to S304, and the feature of red clothes described in the text data is included in the output image obtained through processing.

Here, the preset object mentioned in the present disclosure is an object, such as a person or an animal, on which personalized processing needs to be performed according to the feature described in text data. The input image is a to-be-processed image, and needs to be processed to finally obtain the output image. The output image is a personalized image about the preset object.

In one embodiment, the computer device obtaining an input image including the preset object may include any one of the following: invoking an image capturing device to perform image acquisition on the preset object, to obtain the input image, namely, the input image being an image captured in real time; alternatively, invoking a photographing device to perform video acquisition on the preset object, to obtain a video, and selecting the input image from a plurality of images included in the video (for example, randomly selecting an image as the input image or selecting an image with high image quality as the input image); alternatively, obtaining the input image including the preset object from an image database, namely, the input image being a historically captured image. This embodiment of the present disclosure does not impose a specific limitation on an obtaining mode for the input image.

In one embodiment, the text data may be obtained in real time, or may be obtained from a text database. The text database includes: a plurality of pieces of historical text data that have been used to generate a personalized image. Obtaining the text data in real time is used as an example below to describe the process of obtaining the text data. FIG. 4 is a schematic diagram of an interface for obtaining text data according to an embodiment of the present disclosure. As shown in FIG. 4, a data entry 4011 is configured on a text display interface S401. In response to that the data entry is triggered (for example, by a trigger operation such as a double tap or a long press), a text input panel S402 may be displayed. A preset object may enter text data into the text input panel S402 according to a service requirement. The text input panel S402 supports multi-language and multi-format inputting of text data. For example, the input text data may be: A person wearing a red T-shirt. Further, after the text data is obtained, the computer device may further preprocess the text data. The preprocessing herein may include: at least one processing mode such as data cleaning, normalization, and format conversion (for example, transforming English into Chinese). In this mode, the text data is preprocessed. This facilitates subsequent encoding on the text data and improves image processing efficiency.

S302: Encode the text data to obtain a text embedding.

Specifically, the computer device may invoke a text encoder to encode the text data, to obtain the text embedding. The text encoder may be a text processing model. The text processing model may be a natural language processing (NLP) model, and the natural language processing model may include, but is not limited to: a Word2Vec (word embedding) model, a Transformer model, a Word2Vec (word embedding) model, a bidirectional encoding representation from transformers (BERT) model, and a global vector for word representation (Glo Ve) model.

The following will specifically describe a text data encoding process.

In one embodiment, the computer device encoding the text data to obtain the text embedding specifically includes the following operations: (1) Perform word segmentation on the text data, to obtain a plurality of text words, and extracting a plurality of keywords from the plurality of text words in the text data. The word segmentation is to divide the text data into the text words that are convenient for the user to understand. If the text data is: a man wearing a white T-shirt and having black hair, the plurality of text words obtained after the word segmentation is performed on the text data may include: a, wearing, white T-shirt, black hair, and man. In addition, the keywords may be extracted from the plurality of text words by using a keyword algorithm. For example, the extracted keywords may include: wearing, white T-shirt, black hair, and man.
(2) Invoke the text encoder to perform feature extraction on the extracted keywords, to obtain word vectors of the keywords. Specifically, word embedding may be performed on the keywords by using a text processing model. The text processing model herein may include, but not limited to: a Word2Vec (word embedding) model, a BERT model, and a Glo Ve model, and the word vectors of the keywords may be extracted by using the above models.
(3) Generate the text embedding based on the extracted word vectors. Specifically, the extracted word vectors of the keywords may be combined into the text embedding. For example, a feature dimension of a word vector is 1*256. If the text data includes 256 keywords, a feature dimension of the text embedding is 256*256.

In this implementation, the text encoder (the text processing model) may be invoked to perform accurate and efficient feature extraction on the text data, so that the extracted text embedding is more accurate.

S303: Perform image feature extraction on the input image according to a plurality of predefined data dimensions, to obtain identity embeddings of the preset object in the data dimensions.

Specifically, different data dimensions are configured for indicating that different-layer extraction is performed on image features of the preset object. To be specific, the identity embeddings in different data dimensions are configured for reflecting the image features at different layers of the preset object in the input image. In this embodiment of the present disclosure, the data dimensions include a global dimension and a local dimension. The global dimension is configured for indicating that an identity feature of the preset object is extracted in a global or holistic perspective. For example, a feature such as gender or age of a user may be represented as an identity embedding in the global dimension. The local dimension is configured for indicating that an identity feature of the preset object is extracted in a local or detailed perspective. For example, a feature such as the face and the eyes of a user may be represented as an identity embedding in the local dimension. The following separately describes extraction processes of an identity embedding (also referred to as a global identity embedding) of the preset object in the global dimension and an identity embedding (also referred to as a local identity embedding) of the preset object in the local dimension in detail.

### 1. The Global Identity Embedding of the Preset Object is Extracted According to the Global Dimension.

In one embodiment, the computer device invokes a global identity encoder to perform identity recognition on the preset object in the input image according to the global dimension, to obtain the global identity embedding of the preset object. The global identity embedding is configured for reflecting global identity information of the preset object, such as a position in an image, gender (male or female), age (child, teenager, elderly, or adult), and another feature. The global identity encoder is an image processing model. For example, the image processing model may include, but is not limited to: a convolutional neural network (CNN) model, a recurrent neural network (RNN) model, and a feedforward neural network (FNN) model.

In specific implementation, the global identity encoder includes: a first image sub-encoder and a second image sub-encoder. The first image sub-encoder is an encoder with an unadjustable parameter, for example, a frozen contrastive language-image pre-training (CLIP) image encoder (a vision model that has a high migration capability and that is obtained through training based on text serving as a monitoring signal). The second image sub-encoder is an encoder with an adjustable parameter, for example, an image classification model (a CNN model). That the computer device invokes a global identity encoder to perform identity recognition on the preset object in the input image according to the global dimension, to obtain the global identity embedding of the preset object may include the following operations: (1) Invoke the first image sub-encoder to perform image encoding on the preset object included in an adjusted region image, to obtain a first image feature of the preset object, the first image feature reflecting an attribute feature of the preset object. For example, the attribute feature may include, but is not limited to: a position attribute (a horizontal coordinate, a vertical coordinate, a longitude, a latitude, and the like), a gender attribute (male or female), and an age attribute (child, teenager, or elderly). (2) Invoke the second image sub-encoder to perform image encoding on the preset object included in the adjusted region image, to obtain a second image feature of the preset object, the second image feature reflecting a classification feature of the preset object. For example, the classification feature may include an object type (human, cat, or dog) of the preset object. (3) Obtain the global identity embedding of the preset object based on the first image feature and the second image feature. For example, an average calculating operation may be performed on the first image feature and the second image feature, and a feature obtained after the average calculating operation is used as the global identity embedding. For another example, a weighting operation may be performed on the first image feature and the second image feature, and a feature obtained after the weighting operation is used as the global identity embedding. For still another example, feature alignment may be performed on the first image feature and the second image feature, and the aligned first image feature and the aligned second image feature are stitched, to obtain the global identity embedding. The feature alignment means that the first image feature and the second image feature are unified into the same feature dimension.

In some embodiments, before the computer device invokes a global identity encoder to perform identity recognition on the preset object in the input image according to the global dimension, to obtain the global identity embedding of the preset object, the method further includes the following operations: First, the preset object in the input image is detected to obtain a detection result. For example, a detector may be used to detect the preset object in the input image, and edge extraction is performed on the detected preset object, to obtain the detection result. The detection result includes a detection box (such as a rectangular box, an elliptic box, or a polygonal box). Then, image segmentation is performed on the input image according to the detection result, to obtain a region image including the preset object. The region image is an image within the detection box including the preset object. Finally, a spatial resolution of the global identity encoder may be obtained, and image adjustment is performed on the region image according to the spatial resolution, to obtain an adjusted region image. The image adjustment includes: any one or more of resolution adjustment and image enhancement. For example, the image resolution of the region image may be adjusted to be the spatial resolution of the global identity encoder, thereby facilitating extraction of the identity embeddings of the preset object in the input image. For another example, the process of performing the image adjustment on the region image further includes any one or two of definition adjustment on the region image and image size adjustment on the region image. Image enhancement (for example, improvement of a definition of the region image, image compression, and image size adjustment) may be performed on the region image, thereby more accurately extracting the identity embeddings of the preset object. In this way, the global identity encoder may be more focused on extracting the identity information of the preset object, so that the extracted identity embeddings can better represent the identity feature of the preset object in the input image, thereby improving accuracy of the global identity embedding. In one embodiment, a spatial resolution may be set in the global identity encoder, to adjust the image resolution according to a specified spatial resolution.

By using the foregoing implementation, in the process of extracting the global identity embedding of the preset object, a CLIP image encoder with an unadjustable parameter and an image classification model with an adjustable parameter are both used to perform the feature extraction. This mode has the following two benefits: First, the global identity embedding can be obtained in a training process of a wide range of text image pairs by using strong prior knowledge of the CLIP image encoder. Second, the first image feature obtained from the CLIP image encoder and a CLIP text embedding may share the same semantic space. To encode a plurality of pieces of layered semantic information into the text embedding, a hierarchical semantic feature (the second image feature) may be extracted from a learnable image classification model (for example, a ConvNext model) with rich semantic prior knowledge, the extracted second image feature is projected into a single vector through a plurality of fully connected layers (fully connected layers), and a plurality of first image features are connected, so that a finally extracted global identity embedding is more accurate and more reliable.

### 2. The Local Identity Embedding of the Preset Object is Extracted According to the Local Dimension.

In one embodiment, the computer device invokes a local texture encoder to perform feature extraction on the preset object in the input image according to the local dimension, to obtain the local identity embedding of the preset object. The local identity embedding is configured for reflecting local texture information of the preset object. For example, if a to-be-processed object includes a face of the preset object, the local identity embedding may include: an eye feature (single eyelids and double eyelids), a mouth feature (thick lips and cherry-like lips), a skin type (dry skin, oil skin, mixed dry skin, and mixed oil skin), and another facial feature. For another example, the to-be-processed object includes the head of the preset object, and the local identity embedding may include: high cranial vertex, a hair color (black, brown, and red), a hair style (curly hairs or straight hairs), long hairs or short hair, and another feature. The local texture encoder is also an image processing model, and the image processing model may include, for example, but is not limited to: a convolutional neural network (CNN) model, a recurrent neural network (RNN) model, and a feedforward neural network (FNN) model. Here, a model structure of the global identity encoder and a model structure of the local identity encoder may be the same or may be different. This embodiment of the present disclosure does not impose a specific limitation on this. In addition, a feature dimension of the global identity embedding may be the same as or different from a feature dimension of the local identity embedding. This embodiment of the present disclosure does not impose a specific limitation on this.

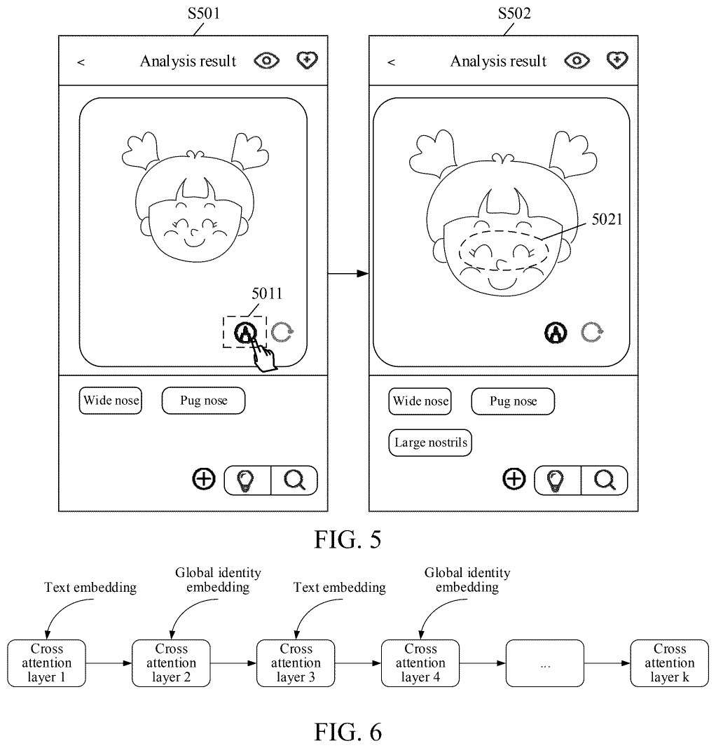

FIG. 5 is a schematic diagram of an interface for extracting a local identity embedding according to an embodiment of the present disclosure. As shown in FIG. 5, during the extraction of the local identity embedding, an input image including a preset object may be displayed on an image display interface S501. The input image includes the head of the preset object, and a circling tool 5011 is set on the image display interface S501. The circling tool is configured for triggering a circled position of the preset object to be highlighted. For example, a user taps the circling tool 5011 on the image display interface S501 to circle the nose part of the preset object, and then zooms on the nose part on an image display interface S502 (as shown in 5021 on the interface S502). In this case, as the nose position is zoomed in, more local features related to the nose part may be displayed on the image display interface S502. For example, the image display interface S502 displays: a wide nose, a pug nose, and large nostrils.

By using the foregoing implementation, in the process of extracting the global identity embedding of the preset object, a key part of the preset object may be highlighted, so that accurate feature extraction is performed on the highlighted key part, to extract local identity embeddings with more details, and the extracted local identity embedding is more accurate and abundant.

S304: Invoke a text-to-image generation model to fuse and recognize the text embedding of the preset object and the identity embeddings of the preset object in the data dimensions, to generate an output image that includes the preset object and that includes a feature described by the text data, the text-to-image generation model including a plurality of cross attention layers, the text embedding and the identity embeddings in the data dimensions being alternately inputted to the cross attention layers, and the output image including an image feature that is described by the text data and that is related to the preset object in the input image. In an embodiment, the text-to-image generation model including the cross attention layers fuses and recognizes the identity embeddings of the preset object in the data dimensions and the text embedding of the preset object by using an interlaced condition mechanism, and finally generates the output image that includes the preset object and the feature described by the text data, thereby implementing personalized image processing on the preset object.

In specific implementation, by using the interlaced condition mechanism, the text-to-image generation model may be invoked to fuse and recognize the identity embeddings of the preset object in the data dimensions and the text embedding of the preset object, to generate a personalized image that is matched with the preset object. The interlaced condition mechanism is configured for: balancing a difference between the identity embedding in any data dimension and the text embedding in the personalized image generation process. The difference herein means: a difference between a feature contribution made by the identity embedding (for example, the global identity embedding) in any data dimension and a feature contribution made by the text embedding to the text-to-image generation model in the personalized image generation process. To be specific, the interlaced condition mechanism can properly balance the identity embedding and the text embedding, to eliminate a problem that the global identity embedding of the preset object plays a leading role and the text embedding loses control over the personalized image, thereby avoiding a conflict between features and improving accuracy of the personalized image.

In one embodiment, the identity embeddings include: a global identity embedding and a local identity embedding. That the computer device uses the interlaced condition mechanism to fuse and recognize the identity embeddings of the preset object in the data dimensions and the text embedding of the preset object, to generate a personalized image that is matched with the preset object may specifically include the following operations: first, invoking the text-to-image generation model by using the interlaced condition mechanism to perform interlaced conditioning on the global identity embedding of the preset object and the text embedding of the preset object, to obtain a first feature result; invoking the text-to-image generation model by using a local enhancement mechanism to perform feature enhancement on the local identity embedding of the preset object, to obtain a second feature result; and next, invoking the text-to-image generation model to decode and recognize the first feature result and the second feature result, to generate the personalized image that is matched with the preset object. Specifically, the text-to-image generation model in the present disclosure is an improved UNet Denoiser. As shown in FIG. 1, the UNet Denoiser includes two parts: an encoder and a decoder. The encoder part is composed of a plurality of cross attention layers, and the decoder part is composed of a plurality of cross attention layers and a plurality of parallel mutual attention layers. Here, the interlaced condition mechanism may be simultaneously applied to the cross attention layers in both the encoder part and the decoder part. The local enhancement mechanism is applied to the mutual attention layers in the decoder part.

The following will respectively describe a specific execution process of the interlaced condition mechanism and a specific execution mechanism of the local enhancement mechanism in detail.

### 1. Interlaced Condition Mechanism:

In one embodiment, the text-to-image generation model includes k cross attention layers. Any cross attention layer is represented as a j^{th} cross attention layer; k and j are both positive integers, and j≤k. That the computer device invokes the text-to-image generation model to perform interlaced conditioning on the global identity embedding of the preset object and the text embedding of the preset object according to the interlaced condition mechanism, to obtain a first feature result specifically includes the following operations: first, inputting the global identity embedding to the j^{th} cross attention layer, and inputting the text embedding to a (j+1)^{th} cross attention layer; and when the k cross attention layers are all inputted with the global identity embedding or the text embedding, respectively performing interlaced conditioning on the global identity embedding and the text embedding based on the k cross attention layers, to obtain the first feature result. FIG. 6 is a flowchart of interlaced conditioning according to an embodiment of the present disclosure. As shown in FIG. 6, first, the text embedding may be inputted to cross attention layer 1, and the global identity embedding may be inputted to cross attention layer 2. Then, the text embedding is inputted to cross attention layer 3, and the global identity embedding is inputted to cross attention layer 4. The rest can be done in the same manner. The text embedding and the global identity embedding are alternately inputted to the k cross attention layers. When the text embedding or the global identity embedding is inputted to each cross attention layer, interlaced conditioning may be performed on the text embedding and the global identity embedding based on the k cross attention layers.

In specific implementation, any cross attention layer inputted with the global identity embedding is represented as Si, and any cross attention layer inputted with the text embedding is represented as Sj. That the computer device respectively performs interlaced conditioning on the global identity embedding and the text embedding based on the k cross attention layers, to obtain the first feature result specifically includes the following operations: first, performing attention extraction on the global identity embedding based on the cross attention layers Si among the k cross attention layers, to obtain an attention feature of the global identity embedding; then, performing attention extraction on the text embedding based on the cross attention layers Sj among the k cross attention layers, to obtain an attention feature of the text embedding; and finally, fusing the attention feature of the global identity embedding with the attention feature of the text embedding, to obtain the first feature result. The first feature result is a result obtained after attention extraction is performed on the text embedding and the global identity embedding. The first feature result is configured for reflecting key information in the text data and important identity feature information of the preset object.

Based on the interlaced condition mechanism, a problem that a user identity feature plays a leading role and the text embedding loses control over the personalized image can be solved. This mechanism allows different conditions to be independently added, without conflicts, thereby balancing the difference between the global identity embedding and the local identity embedding.

### 2. Local Enhancement Mechanism (Also Referred to as Local Identity Enhancement):

In one embodiment, the text-to-image generation model includes: a parallel mutual attention layer and a self attention layer. The mutual attention layer performs feature processing by using a mutual attention mechanism, and the self attention layer performs feature processing by using a self attention mechanism. That the computer device invokes the text-to-image generation model to perform feature enhancement on the local identity embedding of the preset object according to a local enhancement mechanism, to obtain a second feature result specifically includes the following operations: (1) Obtain a background embedding (also referred to as background embedding feature) of the input image, the background embedding being obtained after performing image recognition on a background image except the preset object in the input image. Specifically, an image processing model may be invoked to perform image recognition on the background image, to obtain the background embedding. For example, the image processing model may include, but is not limited to: a CNN model, an RNN model, and an FNN model. (2) Invoke the self attention layer to recognize the background embedding, to obtain a self attention recognition result, and invoke the mutual attention layer to recognize the local identity embedding of the preset object, to obtain a mutual attention recognition result. (3) Perform feature enhancement on the self attention recognition result and the mutual attention recognition result according to the local enhancement mechanism, to obtain the second feature result. For example, the self attention recognition result and the mutual attention recognition result may be added, to obtain the final second feature result. The second feature result may be configured for reflecting a feature result after local information is enhanced.

In specific implementation, the local identity embedding includes a plurality of spatial embeddings. Any two spatial embeddings are represented as: Yk and Yv. That the computer device invokes the mutual attention layer to recognize the local identity embedding of the preset object, to obtain a mutual attention recognition result specifically includes the following operations: first, using the spatial embedding Yk as a key of the mutual attention layer, and using the spatial embedding Yv as a value of the mutual attention layer; and obtaining a mutual attention weight of the mutual attention layer, and fusing the spatial embeddings included in the local identity embedding according to the mutual attention weight, to obtain the mutual attention processing result. The mutual attention layer follows a mutual attention mechanism, and the self attention layer follows a self attention mechanism. The mutual attention mechanism and the self attention mechanism both belong to an attention mechanism. The attention mechanism means that for each word, the word is expressed by using another word in a statement. To be specific, the attention mechanism is a mechanism for capturing a relationship between objects, and different words among the another word have different expression weights for the word. The mutual attention mechanism is also referred to as a multi-head attention mechanism. The “multi-head” attention mechanism is a plurality of attention mechanisms, meaning that relationships at different abstract levels can be captured from different perspectives. In the present disclosure, if the local identity embedding includes n (n is a positive integer) spatial embeddings, any spatial embedding may be expressed based on other n−1 spatial embeddings. In this way, accurate and abundant texture information can be obtained from the extracted local identity embedding.

For example, first, two groups of spatial embeddings (multi-layer spatial embeddings) obtained through encoding by the local texture encoder may be respectively represented as:

$$\{ {y}_{k}^{1} , … , {y}_{k}^{N} \} and \{ {y}_{v}^{1} , … , {y}_{v}^{N} \} ,$$

which are used as a key (K) and a value (V) that are put into the parallel mutual attention layer. An operation in the mutual attention layer is represented as the following formula (1) (to simplify the representation, the superscript is omitted):

$$\{ \begin{matrix}{Q}_{L} = {W}_{Q}^{L} \cdot φ ( {z}_{t} ) ; {K}_{l} = {y}_{k} ; {V}_{l} = {y}_{v} \\ Attention ( {Q}_{l} , {K}_{l} , {V}_{l} ) = softmax ( \frac{{Q}_{l} {K}_{l}^{T}}{\sqrt{d}} ) \cdot {V}_{l}\end{matrix} \qquad ( 1 )$$

In the above formula (1),

$${W}_{Q}^{L}$$

represents a learnable projection matrix in the text-to-image generation model, and the projection matrix includes the attention weights of the spatial embeddings; Q_{L} means a Query matrix in the mutual attention mechanism, namely, an important image feature needing to be concerned about in the mutual attention mechanism; Kₗ is a key matrix in the mutual attention mechanism; Vₗ is a value matrix in the mutual attention mechanism; d is a vector dimension in the above Query matrix, key matrix, and value matrix (namely, [symbol] _{L}, Kₗ, and Vₗ). The formula enables a locally matched identity feature to be fused into the text-to-image generation model according to the attention weights, thereby implementing better identity retention.

Next, an addition operation is performed on the self attention recognition result and the mutual attention recognition result, to obtain the second feature result. The operation process is shown in the following formula (2).

$$Output = λ \times attention ( {Q}_{l} , {K}_{l} , {V}_{l} ) + attention ( {Q}_{ori} , {K}_{ori} , {V}_{ori} ) \qquad ( 2 )$$

In the above formula (2), attention (Qₗ, Kₗ, Vₗ) is the mutual attention recognition result; [symbol] _{L}, Kₗ, and Vₗ are respectively the Query matrix, the key matrix, and the value matrix in the mutual attention mechanism; attention (Qₒᵣᵢ, Kₒᵣᵢ, Vₒᵣᵢ) is the self attention recognition result; [symbol] ₒᵣᵢ, Kₒᵣᵢ, and Vₒᵣᵢ are respectively the Query matrix, the key matrix, and the value matrix in the mutual attention mechanism; and λ is a hyper-parameter. Based on the formula (2), the self attention recognition result and the mutual attention recognition result are added, to obtain the second feature result.

Based on the local enhancement mechanism, in the image generation process, in the present disclosure, abundant texture information is obtained from a reference spatial feature. Based on the self attention layer in the text-to-image generation model, a new parallel mutual attention layer may be introduced to embed local spatial information (i.e., the local identity embedding), so that more texture details in the local identity embedding may be extracted, and an accurate precondition is provided for a personalized image generation process, thereby more accurately generating a personalized image.

In this embodiment of the present disclosure, multi-dimensional image feature extraction on the preset object may be performed, thereby more comprehensively and accurately extracting the identity embeddings of the preset object. In addition, in the process of generating the personalized image based on the identity embeddings and the text feature, the interlaced condition mechanism may be used to balance a conflict between the identity embeddings and the text embedding, so that contributions made by different features are properly balanced in the image generation process, and the generated personalized image can be more accurate.

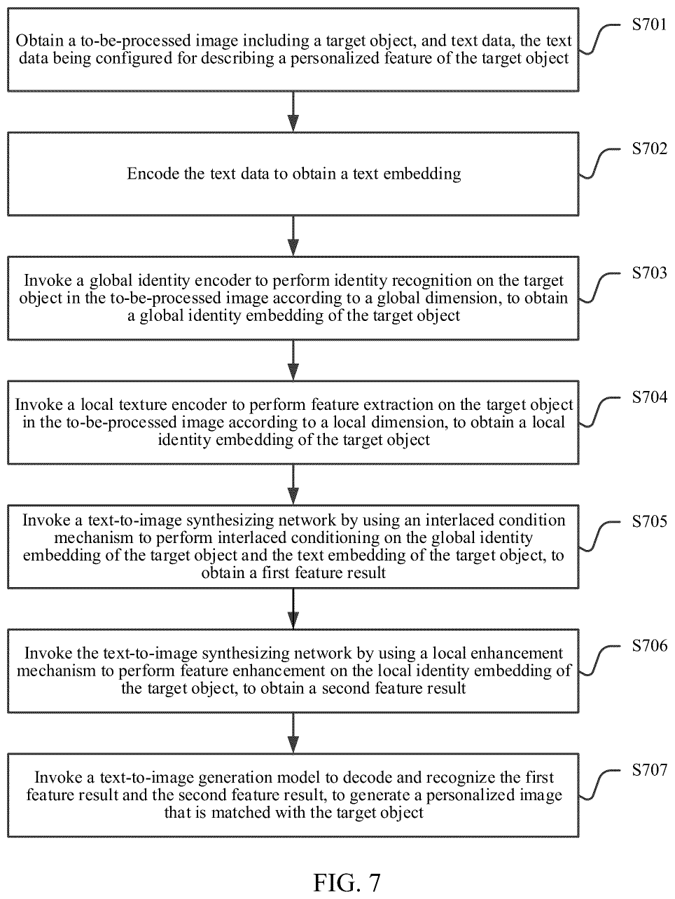

FIG. 7 is a flowchart of another image processing method according to an embodiment of the present disclosure. The image processing method may be performed by a computer device. The computer device may be a terminal device or the server in the image processing system shown in FIG. 2. The image processing method mainly includes, but is not limited to, the following operations S701-S707:

S701: Obtain an input image including a preset object, and obtain text data. The text data is configured for describing a feature that is allowed to be included in an output image corresponding to the input image and that is related to the preset object. In other words, the text data is configured for describing a personalized feature of the preset object, so as to display the personalized feature in a finally processed output image.

In one embodiment, the input image may be an image acquired in real time, or may be an image obtained from a video acquired in real time, or may be a historically captured image. The present disclosure does not impose a specific limitation on this. The text data may be data entered in real time, or the text data may be obtained from a text database. The text database includes: a plurality of pieces of historical text data that have been used to generate a personalized image.

S702: Encode the text data to obtain a text embedding.

In one embodiment, the computer device encoding the text data to obtain the text embedding specifically includes the following operations: (1) Perform word segmentation on the text data, to obtain a plurality of text words, and extracting a plurality of keywords from the plurality of text words in the text data. The word segmentation is to divide the text data into the text words that are convenient for the user to understand. If the text data is: a man wearing a white T-shirt and having black hair, the plurality of text words obtained after the word segmentation is performed on the text data may include: a, wearing, white T-shirt, black hair, and man. In addition, the keywords may be extracted from the plurality of text words by using a keyword algorithm. For example, the extracted keywords may include: wearing, white T-shirt, black hair, and man. (2) Invoke the text encoder to perform feature extraction on the extracted keywords, to obtain word vectors of the keywords. Specifically, word embedding may be performed on the keywords by using a text processing model. The text processing model herein may include, but not limited to: a Word2Vec (word embedding) model, a BERT model, and a GloVe model, and the word vectors of the keywords may be extracted by using the above models. (3) Generate the text embedding based on the extracted word vectors.

S703: Invoke a global identity encoder to perform identity recognition on the preset object in the input image according to a global dimension, to obtain a global identity embedding of the preset object.

In one embodiment, the computer device invoking a global identity encoder to perform identity recognition on the preset object in the input image according to a global dimension to obtain a global identity embedding of the preset object may include the following operations: (1) Invoke the first image sub-encoder to perform image encoding on the preset object included in an adjusted region image, to obtain a first image feature of the preset object, the first image feature reflecting an attribute feature of the preset object. For example, the attribute feature may include, but is not limited to: a position attribute (a horizontal coordinate, a vertical coordinate, a longitude, a latitude, and the like), a gender attribute (male or female), and an age attribute (child, teenager, or elderly). (2) Invoke the second image sub-encoder to perform image encoding on the preset object included in the adjusted region image, to obtain a second image feature of the preset object, the second image feature reflecting a classification feature of the preset object. For example, the classification feature may include an object type (human, cat, or dog) of the preset object. (3) Obtain the global identity embedding of the preset object based on the first image feature and the second image feature. For example, feature fusion is performed on the first image feature and the second image feature, to obtain the global identity embedding. The feature fusion at least includes any one of the following: feature weighting, feature alignment, and feature operation.

S704: Invoke a local texture encoder to perform feature extraction on the preset object in the input image according to a local dimension, to obtain a local identity embedding of the preset object.

In specific implementation, the local texture encoder is also an image processing model, and the image processing model may include, for example, but is not limited to: a convolutional neural network (CNN) model, a recurrent neural network (RNN) model, and a feedforward neural network (FNN) model. Here, a model structure of the global identity encoder and a model structure of the local identity encoder may be the same or may be different. This embodiment of the present disclosure does not impose a specific limitation on this. In addition, a feature dimension of the global identity embedding may be the same as or different from a feature dimension of the local identity embedding. This embodiment of the present disclosure does not impose a specific limitation on this.

Here, for the specific processes of extracting the global identity embedding and the local identity embedding of the preset object in this embodiment of the present disclosure, refer to the related processes in the embodiment of FIG. 3. Details are not described herein again in this embodiment of the present disclosure. In addition, an extraction order of the text embedding, the global identity embedding, and the local identity embedding is not limited. For example, the text embedding may be preferentially extracted, and then the global identity embedding and the local identity embedding are simultaneously extracted. For another example, the global identity embedding may be preferentially extracted; the local identity embedding is then extracted; and the text embedding is finally extracted.

S705: Invoke a text-to-image generation model to perform interlaced conditioning on the global identity embedding of the preset object and the text embedding of the preset object, to obtain a first feature result.

In one embodiment, the text-to-image generation model includes k cross attention layers. Any cross attention layer is represented as a j^{th} cross attention layer; k and j are both positive integers, and j≤k. That the computer device invokes a text-to-image generation model to perform interlaced conditioning on the global identity embedding of the preset object and the text embedding of the preset object according to an interlaced condition mechanism, to obtain a first feature result specifically includes the following operations: first, inputting the global identity embedding to the j^{th} cross attention layer, and inputting the text embedding to a (j+1)^{th} cross attention layer; and when the k cross attention layers are all inputted with the global identity embedding or the text embedding, respectively performing interlaced conditioning on the global identity embedding and the text embedding based on the k cross attention layers, to obtain the first feature result.

S706: Invoke the text-to-image generation model to perform feature enhancement on the local identity embedding of the preset object, to obtain a second feature result.

In one embodiment, the computer device invoking the text-to-image generation model to perform feature enhancement on the local identity embedding of the preset object according to a local enhancement mechanism to obtain a second feature result specifically includes the following operations: first, obtaining a background embedding of the input image, the background embedding being obtained after performing image recognition on a background image except the preset object in the input image; and then, invoking a self attention layer to recognize the background embedding, to obtain a self attention recognition result; invoking a mutual attention layer to recognize the local identity embedding of the preset object, to obtain a mutual attention recognition result; and finally, performing feature enhancement on the self attention recognition result and the mutual attention recognition result according to the local enhancement mechanism, to obtain the second feature result. The text-to-image generation model used in this embodiment of the present disclosure may include, for example, but is not limited to: a Stable diffusion model and an Imagen model. The present disclosure does not impose a specific limitation on a model structure of the text-to-image generation model.

S707: Invoke the text-to-image generation model to decode and recognize the first feature result and the second feature result, to generate an output image, the output image that includes the preset object and that includes a feature described by the text data. The text-to-image generation model includes a plurality of cross attention layers, and the text embedding and the identity embeddings in the data dimensions are alternately inputted to the cross attention layers. The output image includes an image feature that is described by the text data and that is related to the preset object in the input image.

In specific implementation, the first feature result is a result obtained after attention extraction is performed on the text embedding and the global identity embedding. The first feature result is configured for reflecting key information in the text data and important identity feature information of the preset object. The second feature result is configured for reflecting a feature result after local information is enhanced. Therefore, the first feature result and the second feature result are obtained after feature processing is performed on the text embedding, the global identity embedding, and the local identity embedding by using the interlaced condition mechanism and the local enhancement mechanism. Subsequently, after a decoder in the text-to-image generation model is invoked to decode and recognize the first feature result and the second feature result, a personalized image may be generated. The personalized image not only can maintain identity similarity with the preset object in the input image, but also can have the personalized feature described by the text data, thereby meeting a personalized demand of image generation.

It has been shown in practice that comparison results between the personalized image generation method provided in this embodiment of the present disclosure and other methods are shown in the following Table 1:

TABLE 1
Comparison results between the present
disclosure and other methods

| Methods | Identity Similarity | Text Alignment | Time: | |
|---|---|---|---|---|
| Dreambooth | 77.44 | 23.99 | 17 | min |
| Textual Inversion | 62.65 | 20.96 | 62 | min |
| The present | 91.92 | 24.58 | 12 | s |
| disclosure | | | | |

It can be seen from the foregoing table that the image generation method provided in this embodiment of the present disclosure is better than the other methods in terms of Identity Similarity or Text Alignment. It can be seen that the personalized image generation method according to the present disclosure has high accuracy. In addition, the method according to the present disclosure greatly shortens processing time, so that the efficiency of the personalized image generation method according to the present disclosure is high.

The above image processing process may be applicable to a personalized image generation scenario with various service requirements. The following will make a corresponding explanation on an image processing scenario according to this embodiment of the present disclosure.

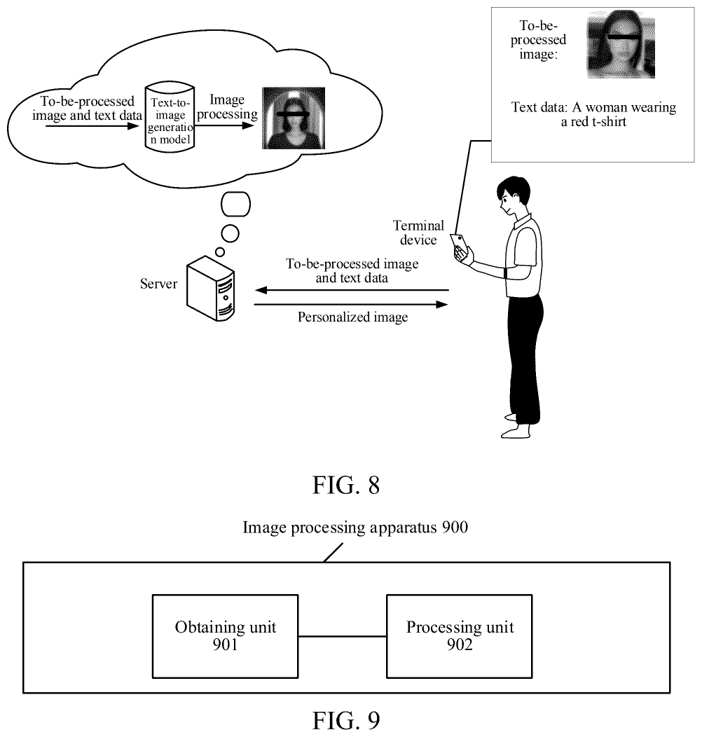

FIG. 8 is a schematic diagram of an image processing scenario according to an embodiment of the present disclosure. As shown in FIG. 8, the image processing scenario involves: a terminal device and a server. The terminal device may be a device used by a preset object, and a text-to-image generation model is configured on the server and is configured for performing image processing on an input image and text data that are uploaded by the terminal device. A personalized image generation process is specifically as follows: (1) A user may upload, through the terminal device, an input image including a preset object and text data (for example: A woman wearing a red t-shirt), and then initiate an image processing request to a server, the image processing request carrying the input image and the text data; (2) In response to the image processing request, after obtaining the input image and the text data, the server may encode the text data to obtain a text embedding, and perform image feature extraction on the preset object in the input image according to a plurality of data dimensions, to obtain identity embeddings of the preset object in the data dimensions. (3) By using the interlaced condition mechanism, the server invokes the text-to-image generation model to fuse and recognize the identity embeddings of the preset object in the data dimensions and the text embedding of the preset object, to generate an output image, namely, to generate a personalized image that is matched with the preset object. (4) The server transmits the personalized image to the terminal device. In the above personalized image generation process, based on the interlaced condition mechanism, a problem that a user identity feature plays a leading role and the text embedding loses control over the personalized image can be solved. This mechanism allows different conditions to be independently added, without conflicts, thereby balancing a difference between the global identity embedding and the local identity embedding. In addition, in the present disclosure, abundant texture information is obtained from a reference spatial feature. Based on the self attention layer in the text-to-image generation model, a new parallel mutual attention layer may be introduced to embed local spatial information (i.e., the local identity embedding), so that more texture details in the local identity embedding may be extracted, and an accurate precondition is provided for a personalized image generation process, thereby more accurately generating a personalized image.

The above describes the method according to the embodiments of the present disclosure in detail. To better implement the above scheme in the embodiments of the present disclosure, correspondingly, the following provides an apparatus according to an embodiment of the present disclosure. Next, the relevant apparatus according to an embodiment of the present disclosure will be correspondingly introduced in conjunction with the image processing scheme according to the embodiments of the present disclosure.

FIG. 9 is a schematic structural diagram of an image processing apparatus according to an embodiment of the present disclosure. As shown in FIG. 9, the image processing apparatus 900 may be applied to the computer device (such as the terminal device or the server) mentioned in the foregoing embodiments. Specifically, the image processing apparatus 900 may be a computer program (including a program code) executed on the computer device. For example, the image processing apparatus 900 is application software. The image processing apparatus 900 may be configured to perform the corresponding operations in the image processing method according to the embodiments of the present disclosure. In specific implementation, the image processing apparatus 900 may specifically include:
an obtaining unit 901, configured to: obtain an input image including a preset object, and obtain text data; and
a processing unit 902, configured to encode the text data to obtain a text embedding;
the processing unit 902 being further configured to perform image feature extraction on the input image according to a plurality of predefined data dimensions, to obtain identity embeddings of the preset object in the data dimensions; and
the processing unit 902 being further configured to: invoke a text-to-image generation model to fuse and recognize the text embedding of the preset object and the identity embeddings of the preset object in the data dimensions, to generate an output image, the text-to-image generation model including a plurality of cross attention layers, and the text embedding and the identity embeddings in the data dimensions being alternately inputted to the cross attention layers; and the output image including an image feature that is described by the text data and that is related to the preset object in the input image.

In one embodiment, the data dimensions include a global dimension and a local dimension. The identity embedding of the preset object in the global dimension is represented as a global identity embedding, and the identity embedding of the preset object in the local dimension is represented as a local identity embedding.

When performing image feature extraction on the preset object in the input image according to the plurality of predefined data dimensions, to obtain the identity embeddings of the preset object in the data dimensions, the processing unit 902 is configured to perform the following operations:
invoking a global identity encoder to perform identity recognition on the preset object in the input image according to the global dimension, to obtain the global identity embedding of the preset object; and invoking a local texture encoder to perform texture feature extraction on the preset object in the input image according to the local dimension, to obtain the local identity embedding of the preset object.

In one embodiment, before invoking the global identity encoder to perform identity recognition on the preset object in the input image according to the global dimension, to obtain the global identity embedding of the preset object, the processing unit 902 is further configured to perform the following operations:
detecting the preset object in the input image, to obtain a detection result; performing image segmentation on the input image according to the detection result, to obtain a region image that includes the preset object; and obtaining a spatial resolution of the global identity encoder, and performing image adjustment on the region image according to the spatial resolution, to obtain an adjusted region image. The image adjustment includes: adjusting a resolution; and the process of performing image adjustment on the region image further includes performing, on the region image, at least one of definition adjustment or image size adjustment.

In one embodiment, the global identity encoder includes: a first image sub-encoder and a second image sub-encoder. When invoking the global identity encoder to perform identity recognition on the preset object in the input image according to the global dimension, to obtain the global identity embedding of the preset object, the processing unit 902 is configured to perform the following operations:
invoking the first image sub-encoder to perform image encoding on the preset object included in the adjusted region image, to obtain a first image feature of the preset object, the first image feature reflecting an attribute feature of the preset object; invoking the second image sub-encoder to perform image encoding on the preset object included in the adjusted region image, to obtain a second image feature of the preset object, the second image feature reflecting a classification feature of the preset object; and obtaining the global identity embedding of the preset object based on the first image feature and the second image feature.

In one embodiment, when obtaining the global identity embedding of the preset object based on the first image feature and the second image feature, the processing unit 902 is configured to perform any one of the following:
performing an average calculating operation on the first image feature and the second image feature, and determining an image feature obtained after the average calculating operation as the global identity embedding of the preset object;
performing a weighting operation on the first image feature and the second image feature, and determining an image feature obtained after the weighting operation as the global identity embedding of the preset object; and
performing feature alignment on the first image feature and the second image feature, and combining the first image feature and the second image feature that are subjected to the feature alignment into the global identity embedding of the preset object.

In one embodiment, the identity embeddings include: a global identity embedding and a local identity embedding. When invoking the text-to-image generation model to fuse and recognize the text embedding of the preset object and the identity embeddings of the preset object in the data dimensions, to generate the output image, the processing unit 902 is configured to perform the following operations:
invoking the text-to-image generation model to perform interlaced conditioning on the global identity embedding of the preset object and the text embedding of the preset object, to obtain a first feature result; invoking the text-to-image generation model to perform feature enhancement on the local identity embedding of the preset object, to obtain a second feature result; and invoking the text-to-image generation model to decode and recognize the first feature result and the second feature result, to generate the output image.

In one embodiment, the text-to-image generation model includes k cross attention layers. Any cross attention layer is represented as a j^{th} cross attention layer; k and j are both positive integers, and j≤k. When invoking the text-to-image generation model to perform interlaced conditioning on the global identity embedding of the preset object and the text embedding of the preset object, to obtain the first feature result, the processing unit 902 is configured to perform the following operations:
inputting the global identity embedding to the j^{th} cross attention layer, and inputting the text embedding to a (j+1)^{th} cross attention layer; and when the k cross attention layers are all inputted with the global identity embedding or the text embedding, respectively performing interlaced conditioning on the global identity embedding and the text embedding based on the k cross attention layers, to obtain the first feature result.

In one embodiment, any cross attention layer inputted with the global identity embedding is represented as Si, and any cross attention layer inputted with the text embedding is represented as Sj. When respectively performing interlaced conditioning on the global identity embedding and the text embedding based on the k cross attention layers, to obtain the first feature result, the processing unit 902 is configured to perform the following operations:
performing attention extraction on the global identity embedding based on the cross attention layers Si among the k cross attention layers, to obtain an attention feature of the global identity embedding; performing attention extraction on the text embedding based on the cross attention layers Sj among the k cross attention layers, to obtain an attention feature of the text embedding; and fusing the attention feature of the global identity embedding with the attention feature of the text embedding, to obtain the first feature result.

In one embodiment, the text-to-image generation model includes: a mutual attention layer and a self attention layer. When invoking the text-to-image generation model to perform feature enhancement on the local identity embedding of the preset object, to obtain the second feature result, the processing unit 902 is configured to perform the following operations:
obtaining a background embedding of the input image, the background embedding being obtained after performing image recognition on a background image except the preset object in the input image; invoking the self attention layer to recognize the background embedding, to obtain a self attention recognition result; invoking the mutual attention layer to recognize the local identity embedding of the preset object, to obtain a mutual attention recognition result; and performing feature enhancement on the self attention recognition result and the mutual attention recognition result, to obtain the second feature result.

In one embodiment, the local identity embedding includes a plurality of spatial embeddings. Any two spatial embeddings are represented as: Yk and Yv. When invoking the mutual attention layer to recognize the local identity embedding of the preset object, to obtain the mutual attention recognition result, the processing unit 902 is configured to perform the following operations:
using the spatial embedding Yk as a key of the mutual attention layer, and using the spatial embedding Yv as a value of the mutual attention layer; obtaining a mutual attention weight of the mutual attention layer; and fusing the spatial embeddings included in the local identity embedding according to the mutual attention weight, to obtain the mutual attention processing result.

In one embodiment, when encoding the text data to obtain the text embedding, the processing unit 902 is configured to perform the following operations:
performing word segmentation on the text data, to obtain a plurality of text words, and extracting a plurality of keywords from the plurality of text words in the text data; invoking a text encoder to perform feature extraction on the extracted keywords, to obtain word vectors of the keywords; and generating the text embedding based on the extracted word vectors.

In this embodiment of the present disclosure, for specific implementations of the operations performed by the units of the apparatus and corresponding effects that can be generated, refer to the related descriptions of the foregoing embodiments. Details are not described herein again.

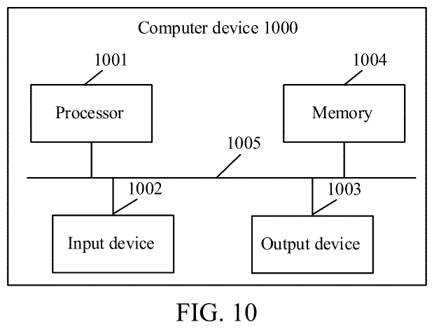

FIG. 10 is a schematic structural diagram of a computer device according to an embodiment of the present disclosure. The computer device 1000 is configured to perform the operations performed by the terminal device or the server in the foregoing method embodiments. The computer device 1000 includes: one or more processors 1001, one or more input devices 1002, one or more output devices 1003, and a memory 1004. The processor 1001, the input device 1002, the output device 1003, and the memory 1004 described above are connected through a bus 1005. Specifically, the memory 1004 is configured to store a computer program. The computer program includes a computer instruction. The processor 1001 is configured to: invoke the program instruction stored in the memory 1004 and perform the following operations:
obtaining an input image including a preset object, and obtaining text data; encoding the text data to obtain a text embedding; performing image feature extraction on the input image according to a plurality of predefined data dimensions, to obtain identity embeddings of the preset object in the data dimensions; and invoking a text-to-image generation model to fuse and recognize the text embedding of the preset object and the identity embeddings of the preset object in the data dimensions, to generate an output image, the text-to-image generation model including a plurality of cross attention layers, and the text embedding and the identity embeddings in the data dimensions being alternately inputted to the cross attention layers; and the output image including an image feature that is described by the text data and that is related to the preset object in the input image.

In one embodiment, the data dimensions include a global dimension and a local dimension. The identity embedding of the preset object in the global dimension is represented as a global identity embedding, and the identity embedding of the preset object in the local dimension is represented as a local identity embedding. When performing image feature extraction on the preset object in the input image according to the plurality of predefined data dimensions, to obtain the identity embeddings of the preset object in the data dimensions, the processor 1001 is configured to perform the following operations:
invoking a global identity encoder to perform identity recognition on the preset object in the input image according to the global dimension, to obtain the global identity embedding of the preset object; and invoking a local texture encoder to perform texture feature extraction on the preset object in the input image according to the local dimension, to obtain the local identity embedding of the preset object.

In one embodiment, before invoking the global identity encoder to perform identity recognition on the preset object in the input image according to the global dimension, to obtain the global identity embedding of the preset object, the processor 1001 is further configured to perform the following operations:
detecting the preset object in the input image, to obtain a detection result; performing image segmentation on the input image according to the detection result, to obtain a region image that includes the preset object; and obtaining a spatial resolution of the global identity encoder, and performing image adjustment on the region image according to the spatial resolution, to obtain an adjusted region image. The image adjustment includes: adjusting a resolution; and the process of performing image adjustment on the region image further includes performing one or two of definition adjustment and image size adjustment on the region image.

In one embodiment, the global identity encoder includes: a first image sub-encoder and a second image sub-encoder. When invoking the global identity encoder to perform identity recognition on the preset object in the input image according to the global dimension, to obtain the global identity embedding of the preset object, the processor 1001 is configured to perform the following operations:
invoking the first image sub-encoder to perform image encoding on the preset object included in the adjusted region image, to obtain a first image feature of the preset object, the first image feature reflecting an attribute feature of the preset object; invoking the second image sub-encoder to perform image encoding on the preset object included in the adjusted region image, to obtain a second image feature of the preset object, the second image feature reflecting a classification feature of the preset object; and obtaining the global identity embedding of the preset object based on the first image feature and the second image feature.

In one embodiment, when obtaining the global identity embedding of the preset object based on the first image feature and the second image feature, the processor 1001 is configured to perform any one of the following:
performing an average calculating operation on the first image feature and the second image feature, and determining an image feature obtained after the average calculating operation as the global identity embedding of the preset object;
performing a weighting operation on the first image feature and the second image feature, and determining an image feature obtained after the weighting operation as the global identity embedding of the preset object; and
performing feature alignment on the first image feature and the second image feature, and combining the first image feature and the second image feature that are subjected to the feature alignment into the global identity embedding of the preset object.

In one embodiment, the identity embeddings include: a global identity embedding and a local identity embedding. When invoking the text-to-image generation model to fuse and recognize the text embedding of the preset object and the identity embeddings of the preset object in the data dimensions, to generate the output image, the processor 1001 is configured to perform the following operations:
invoking the text-to-image generation model to perform interlaced conditioning on the global identity embedding of the preset object and the text embedding of the preset object, to obtain a first feature result; invoking the text-to-image generation model to perform feature enhancement on the local identity embedding of the preset object, to obtain a second feature result; and invoking the text-to-image generation model to decode and recognize the first feature result and the second feature result, to generate the output image.

In one embodiment, the text-to-image generation model includes k cross attention layers. Any cross attention layer is represented as a j^{th} cross attention layer; k and j are both positive integers, and j≤k. When invoking the text-to-image generation model by using an interlaced condition mechanism to perform interlaced conditioning on the global identity embedding of the preset object and the text embedding of the preset object, to obtain the first feature result, the processor 1001 is configured to perform the following operations:
inputting the global identity embedding to the j^{th} cross attention layer, and inputting the text embedding to a (j+1)^{th} cross attention layer; and when the k cross attention layers are all inputted with the global identity embedding or the text embedding, respectively performing interlaced conditioning on the global identity embedding and the text embedding based on the k cross attention layers, to obtain the first feature result.

In one embodiment, any cross attention layer inputted with the global identity embedding is represented as Si, and any cross attention layer inputted with the text embedding is represented as Sj. When respectively performing interlaced conditioning on the global identity embedding and the text embedding based on the k cross attention layers, to obtain the first feature result, the processor 1001 is configured to perform the following operations:
performing attention extraction on the global identity embedding based on the cross attention layers Si among the k cross attention layers, to obtain an attention feature of the global identity embedding; performing attention extraction on the text embedding based on the cross attention layers Sj among the k cross attention layers, to obtain an attention feature of the text embedding; and fusing the attention feature of the global identity embedding with the attention feature of the text embedding, to obtain the first feature result.

In one embodiment, the text-to-image generation model includes: a mutual attention layer and a self attention layer. When invoking the text-to-image generation model to perform feature enhancement on the local identity embedding of the preset object, to obtain the second feature result, the processor 1001 is configured to perform the following operations:
obtaining a background embedding of the input image, the background embedding being obtained after performing image recognition on a background image except the preset object in the input image; invoking the self attention layer to recognize the background embedding, to obtain a self attention recognition result; invoking the mutual attention layer to recognize the local identity embedding of the preset object, to obtain a mutual attention recognition result; and performing feature enhancement on the self attention recognition result and the mutual attention recognition result, to obtain the second feature result.

In one embodiment, the local identity embedding includes a plurality of spatial embeddings. Any two spatial embeddings are represented as: Yk and Yv. When invoking the mutual attention layer to recognize the local identity embedding of the preset object, to obtain the mutual attention recognition result, the processor 1001 is configured to perform the following operations:
using the spatial embedding Yk as a key of the mutual attention layer, and using the spatial embedding Yv as a value of the mutual attention layer; obtaining a mutual attention weight of the mutual attention layer; and fusing the spatial embeddings included in the local identity embedding according to the mutual attention weight, to obtain the mutual attention processing result.

In one embodiment, when encoding the text data to obtain the text embedding, the processor 1001 is configured to perform the following operations:
performing word segmentation on the text data, to obtain a plurality of text words, and extracting a plurality of keywords from the plurality of text words in the text data; invoking a text encoder to perform feature extraction on the extracted keywords, to obtain word vectors of the keywords; and generating the text embedding based on the extracted word vectors.

In this embodiment of the present disclosure, for specific implementations of the operations performed by the processor of the computer device and corresponding effects that can be generated, refer to the related descriptions of the foregoing embodiments. Details are not described herein again.

Here, an embodiment of the present disclosure further provides a computer storage medium, having a computer program stored therein. The computer program includes a program instruction. When a processor executes the program instruction, the processor can perform the method in the foregoing corresponding embodiment. Therefore, details are not described herein again. For technical details that are not disclosed in the computer storage medium embodiments of the present disclosure, refer to the descriptions of the method embodiments of the present disclosure. In an example, the program instruction may be deployed on a computer device, or deployed to be executed on a plurality of computer devices at the same location, or deployed to be executed on a plurality of computer devices that are distributed in a plurality of locations and that are interconnected by using a communication network.

According to an aspect of the present disclosure, an embodiment of the present disclosure further provides a computer program product or a computer program. The computer program product or the computer program includes a computer instruction. The computer instruction is stored in a computer-readable storage medium. A processor of a computer device reads the computer instruction from the computer-readable storage medium, and the processor executes the computer-readable instruction, so that the computer device can perform the method in the foregoing corresponding embodiment. Therefore, details are not described herein again.

A person of ordinary skill in the art may be aware that, in combination with the examples described in embodiments disclosed in the present disclosure, units and algorithm operations may be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of the present disclosure.

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on a computer, all or some of the processes or functions according to the embodiments of the present disclosure are produced. The computer may be a general-purpose computer, a special-purpose computer, a computer network, or other programmable devices. The computer instruction may be stored in the computer-readable storage medium or transmitted through the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium capable of being accessed by a computer or include one or more data processing devices integrated by an available medium, such as a server and a data center. The usable medium may be a magnetic medium (for example, a soft disk, a hard disk, or a magnetic tape), an optical medium (for example, a DVD), a semiconductor medium (for example, a solid state drive (SSD)), or the like.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. An image processing method, comprising:
obtaining an input image comprising a preset object, and obtaining text data;
encoding the text data to obtain a text embedding feature;
performing image feature extraction on the input image according to a plurality of predefined data dimensions, to obtain identity embedding features of the preset object in the data dimensions; and
invoking a text-to-image generation model to fuse and recognize the text embedding feature of the preset object and the identity embedding features of the preset object in the data dimensions, to generate an output image, the text-to-image generation model comprising a plurality of cross attention layers, and the text embedding feature and the identity embedding features in the data dimensions being alternately inputted to the plurality of cross attention layers; and the output image comprising an image feature described by the text data and related to the preset object in the input image.

2. The method according to claim 1, wherein the data dimensions comprise a global dimension and a local dimension; the identity embedding feature of the preset object in the global dimension is represented as a global identity embedding feature, and the identity embedding feature of the preset object in the local dimension is represented as a local identity embedding feature; and
the performing image feature extraction on the input image according to a plurality of predefined data dimensions, to obtain identity embedding features of the preset object in the data dimensions comprises:
invoking a global identity encoder to perform identity recognition on the preset object in the input image according to the global dimension, to obtain the global identity embedding feature of the preset object; and
invoking a local texture encoder to perform texture feature extraction on the preset object in the input image according to the local dimension, to obtain the local identity embedding feature of the preset object.

3. The method according to claim 1, further comprising:
detecting the preset object in the input image, to obtain a detection result;
performing image segmentation on the input image according to the detection result, to obtain a region image containing the preset object; and
obtaining a spatial resolution of the global identity encoder, and performing image adjustment on the region image according to the spatial resolution, to obtain an adjusted region image; the image adjustment comprising: resolution adjustment; and
the process of performing image adjustment on the region image further comprising performing, on the region image, at least one of definition adjustment or image size adjustment.

4. The method according to claim 1, wherein the global identity encoder comprises: a first image sub-encoder and a second image sub-encoder; and the invoking a global identity encoder to perform identity recognition on the preset object in the input image according to the global dimension, to obtain the global identity embedding feature of the preset object comprises:
invoking a first image sub-encoder to perform image encoding on the preset object comprised in the adjusted region image, to obtain a first image feature of the preset object, the first image feature reflecting an attribute feature of the preset object;
invoking a second image sub-encoder to perform image encoding on the preset object comprised in the adjusted region image, to obtain a second image feature of the preset object, the second image feature reflecting a classification feature of the preset object;
obtaining the global identity embedding feature of the preset object based on the first image feature and the second image feature.

5. The method according to claim 4, wherein the obtaining the global identity embedding feature of the preset object based on the first image feature and the second image feature comprises one of:
performing an average calculating operation on the first image feature and the second image feature, and determining an image feature obtained after the average calculating operation as the global identity embedding feature of the preset object;
performing a weighting operation on the first image feature and the second image feature, and determining an image feature obtained after the weighting operation as the global identity embedding feature of the preset object; and
performing feature alignment on the first image feature and the second image feature, and combining the first image feature and the second image feature that are subjected to the feature alignment into the global identity embedding feature of the preset object.

6. The method according to claim 1, wherein the identity embedding features comprise: a global identity embedding feature and a local identity embedding feature; the invoking a text-to-image generation model to fuse and recognize the text embedding feature of the preset object and the identity embedding features of the preset object in the data dimensions, to generate an output image comprises:
invoking the text-to-image generation model to perform interlaced conditioning on the global identity embedding feature of the preset object and the text embedding feature of the preset object, to obtain a first feature result;
invoking the text-to-image generation model to perform feature enhancement on the local identity embedding feature of the preset object, to obtain a second feature result; and
invoking the text-to-image generation model to decode and recognize the first feature result and the second feature result, to generate the output image.

7. The method according to claim 6, wherein the text-to-image generation model comprises k cross attention layers; a cross attention layer is represented as a j^{th} cross attention layer; k and j are both positive integers, and j≤k; and
the invoking the text-to-image generation model to perform interlaced conditioning on the global identity embedding feature of the preset object and the text embedding feature of the preset object, to obtain a first feature result comprises:
inputting the global identity embedding feature to the j^{th} cross attention layer, and inputting the text embedding feature to a (j+1)^{th} cross attention layer; and
in response to the k cross attention layers being inputted with the global identity embedding feature or the text embedding feature, respectively performing interlaced conditioning on the global identity embedding feature and the text embedding feature based on the k cross attention layers, to obtain the first feature result.

8. The method according to claim 7, wherein a cross attention layer inputted with the global identity embedding feature is represented as Si, and a cross attention layer inputted with the text embedding feature is represented as Sj; and the respectively performing interlaced conditioning on the global identity embedding feature and the text embedding feature based on the k cross attention layers, to obtain the first feature result comprises:
performing attention extraction on the global identity embedding feature based on the cross attention layers Si among the k cross attention layers, to obtain an attention feature of the global identity embedding feature;
performing attention extraction on the text embedding feature based on the cross attention layers Sj among the k cross attention layers, to obtain an attention feature of the text embedding feature; and
fusing the attention feature of the global identity embedding feature with the attention feature of the text embedding feature, to obtain the first feature result.

9. The method according to claim 1, wherein the text-to-image generation model comprises: a mutual attention layer and a self attention layer; and
the invoking the text-to-image generation model to perform feature enhancement on the local identity embedding feature of the preset object, to obtain a second feature result comprises:
obtaining a background embedding feature of the input image, the background embedding feature being obtained after performing image recognition on a background image except the preset object in the input image;
invoking the self attention layer to recognize the background embedding feature, to obtain a self attention recognition result;
invoking the mutual attention layer to recognize the local identity embedding feature of the preset object, to obtain a mutual attention recognition result; and
performing feature enhancement on the self attention recognition result and the mutual attention recognition result, to obtain the second feature result.

10. The method according to claim 1, wherein the local identity embedding feature comprises a plurality of spatial embeddings; two spatial embeddings are represented as: Yk and Yv; and
the invoking the mutual attention layer to recognize the local identity embedding feature of the preset object, to obtain a mutual attention recognition result comprises:
using the spatial embedding Yk as a key of the mutual attention layer, and using the spatial embedding Yv as a value of the mutual attention layer;
obtaining a mutual attention weight of the mutual attention layer; and
fusing the spatial embeddings comprised in the local identity embedding feature according to the mutual attention weight, to obtain the mutual attention recognition result.

11. The method according to claim 1, wherein the encoding the text data to obtain a text embedding feature comprises:
performing word segmentation on the text data, to obtain a plurality of text words, and extracting a plurality of keywords from the plurality of text words in the text data;
invoking a text encoder to perform feature extraction on the extracted keywords, to obtain word vectors of the keywords; and
generating the text embedding feature based on the extracted word vectors.

12. An image processing apparatus, comprising:
a memory and a processor,
the memory having one or more computer programs stored therein, and
the processor being configured to: load the one or more computer programs to implement:
obtaining an input image comprising a preset object, and obtaining text data;
encoding the text data to obtain a text embedding feature;
performing image feature extraction on the input image according to a plurality of predefined data dimensions, to obtain identity embedding features of the preset object in the data dimensions; and
invoking a text-to-image generation model to fuse and recognize the text embedding feature of the preset object and the identity embedding features of the preset object in the data dimensions, to generate an output image, the text-to-image generation model comprising a plurality of cross attention layers, and the text embedding feature and the identity embedding features in the data dimensions being alternately inputted to the plurality of cross attention layers; and the output image comprising an image feature described by the text data and related to the preset object in the input image.

13. The apparatus according to claim 12, wherein the data dimensions comprise a global dimension and a local dimension; the identity embedding feature of the preset object in the global dimension is represented as a global identity embedding feature, and the identity embedding feature of the preset object in the local dimension is represented as a local identity embedding feature; and
the performing image feature extraction on the input image according to a plurality of predefined data dimensions, to obtain identity embedding features of the preset object in the data dimensions comprises:
invoking a global identity encoder to perform identity recognition on the preset object in the input image according to the global dimension, to obtain the global identity embedding feature of the preset object; and
invoking a local texture encoder to perform texture feature extraction on the preset object in the input image according to the local dimension, to obtain the local identity embedding feature of the preset object.

14. The apparatus according to claim 12, further comprising:
detecting the preset object in the input image, to obtain a detection result;
performing image segmentation on the input image according to the detection result, to obtain a region image containing the preset object; and
obtaining a spatial resolution of the global identity encoder, and performing image adjustment on the region image according to the spatial resolution, to obtain an adjusted region image; the image adjustment comprising: resolution adjustment; and
the process of performing image adjustment on the region image further comprising performing, on the region image, at least one of definition adjustment or image size adjustment.

15. The apparatus according to claim 12, wherein the global identity encoder comprises: a first image sub-encoder and a second image sub-encoder; and the invoking a global identity encoder to perform identity recognition on the preset object in the input image according to the global dimension, to obtain the global identity embedding feature of the preset object comprises:
invoking a first image sub-encoder to perform image encoding on the preset object comprised in the adjusted region image, to obtain a first image feature of the preset object, the first image feature reflecting an attribute feature of the preset object;
invoking a second image sub-encoder to perform image encoding on the preset object comprised in the adjusted region image, to obtain a second image feature of the preset object, the second image feature reflecting a classification feature of the preset object;
obtaining the global identity embedding feature of the preset object based on the first image feature and the second image feature.

16. The apparatus according to claim 15, wherein the obtaining the global identity embedding feature of the preset object based on the first image feature and the second image feature comprises one of:
performing an average calculating operation on the first image feature and the second image feature, and determining an image feature obtained after the average calculating operation as the global identity embedding feature of the preset object;
performing a weighting operation on the first image feature and the second image feature, and determining an image feature obtained after the weighting operation as the global identity embedding feature of the preset object; and
performing feature alignment on the first image feature and the second image feature, and combining the first image feature and the second image feature that are subjected to the feature alignment into the global identity embedding feature of the preset object.

17. The apparatus according to claim 12, wherein the identity embedding features comprise: a global identity embedding feature and a local identity embedding feature; the invoking a text-to-image generation model to fuse and recognize the text embedding feature of the preset object and the identity embedding features of the preset object in the data dimensions, to generate an output image comprises:
invoking the text-to-image generation model to perform interlaced conditioning on the global identity embedding feature of the preset object and the text embedding feature of the preset object, to obtain a first feature result;
invoking the text-to-image generation model to perform feature enhancement on the local identity embedding feature of the preset object, to obtain a second feature result; and
invoking the text-to-image generation model to decode and recognize the first feature result and the second feature result, to generate the output image.

18. The apparatus according to claim 17, wherein the text-to-image generation model comprises k cross attention layers; a cross attention layer is represented as a j^{th} cross attention layer; k and j are both positive integers, and j≤k; and
the invoking the text-to-image generation model to perform interlaced conditioning on the global identity embedding feature of the preset object and the text embedding feature of the preset object, to obtain a first feature result comprises:
inputting the global identity embedding feature to the j^{th} cross attention layer, and inputting the text embedding feature to a (j+1)^{th} cross attention layer; and
in response to the k cross attention layers being inputted with the global identity embedding feature or the text embedding feature, respectively performing interlaced conditioning on the global identity embedding feature and the text embedding feature based on the k cross attention layers, to obtain the first feature result.

19. The apparatus according to claim 18, wherein a cross attention layer inputted with the global identity embedding feature is represented as Si, and a cross attention layer inputted with the text embedding feature is represented as Sj; and the respectively performing interlaced conditioning on the global identity embedding feature and the text embedding feature based on the k cross attention layers, to obtain the first feature result comprises:
performing attention extraction on the global identity embedding feature based on the cross attention layers Si among the k cross attention layers, to obtain an attention feature of the global identity embedding feature;
performing attention extraction on the text embedding feature based on the cross attention layers Sj among the k cross attention layers, to obtain an attention feature of the text embedding feature; and
fusing the attention feature of the global identity embedding feature with the attention feature of the text embedding feature, to obtain the first feature result.

20. A non-transitory computer-readable storage medium, having a computer program stored therein, the computer program being adapted to be loaded and executed by a processor to perform:
obtaining an input image comprising a preset object, and obtaining text data;
encoding the text data to obtain a text embedding feature;
performing image feature extraction on the input image according to a plurality of predefined data dimensions, to obtain identity embedding features of the preset object in the data dimensions; and
invoking a text-to-image generation model to fuse and recognize the text embedding feature of the preset object and the identity embedding features of the preset object in the data dimensions, to generate an output image, the text-to-image generation model comprising a plurality of cross attention layers, and the text embedding feature and the identity embedding features in the data dimensions being alternately inputted to the plurality of cross attention layers; and the output image comprising an image feature described by the text data and related to the preset object in the input image.
